(19) United States
(12) Patent Application Publication
(10) Pub. No.: US 2012/0109783 A1
(43) Pub. Date: May 3, 2012

(54) Product information search

(75) Inventors: Chenguang Le, Hangzhou (CN); Junlin Zhu, Hangzhou (CN); Yuanhu Yao, Hangzhou (CN); Weiyu Chen, Hangzhou (CN); Mulan Zhang, Hangzhou (CN); Maojian Fu, Hangzhou (CN)

(73) Assignee: Alibaba Group Holding Limited

(21) Appl. No.: 13/373,033

(22) Filed: Nov. 2, 2011

(30) Foreign Application Priority Data
Nov. 3, 2010 (CN) 201010531327.3

(51) Int. Cl. G06Q 30/06

(52) U.S. Cl. 705/26.62

(57) ABSTRACT

Searching for product information is disclosed, including: receiving a search request that includes at least a desired purchase quantity and a desired unit price; determining a preset purchase quantity that corresponds to the desired purchase quantity, wherein the determined preset purchase quantity is selected from a set of preset purchase quantities and each of the set of preset purchase quantities is associated with a different predetermined number of units; generating a search query that includes at least the determined preset purchase quantity and the desired unit price; and using the search query to search for matching products, wherein a matching product is associated with a unit price corresponding to the determined preset purchase quantity that corresponds to the desired unit price.

### CROSS REFERENCE TO OTHER APPLICATIONS

This application claims priority to People's Republic of China Patent Application No. 201010531327.3 entitled A METHOD, SYSTEM AND DEVICE FOR SEARCHING PRODUCT INFORMATION filed Nov. 3, 2010 which is incorporated herein by reference for all purposes.

### FIELD OF THE INVENTION

The present application relates to the field of Internet-based applications. In particular, it relates to searching for product information.

### BACKGROUND OF THE INVENTION

At e-commerce websites, an e-commerce seller (e.g., an enterprise or an individual that sells products through e-commerce websites) can input/submit information regarding a product that is for sale to the website. This submitted product information is typically stored (e.g., at a back-end system) and displayed at the web page (e.g., by a front-end system) associated with the product at the e-commerce website to inform a potential e-commerce buyer (e.g., enterprise or an individual that purchases products through e-commerce websites) about available products. Sometimes, the seller will input different unit prices for the same product because each unit price could correspond to a different range of purchase quantities of the product. Each range of purchase quantities can be denoted by a “purchase quantity range lower limit,” which is the quantity of the smallest purchase order that can be placed for a certain unit price of the product and “purchase quantity range upper limit,” which is the quantity of the largest purchase order that can be placed at that same price for the product.

E-commerce buyers at an e-commerce website can create search requests for products at the front end (e.g., a web browser-based user interface). Conventionally, product information search requests from an e-commerce buyer at an e-commerce website front end are generally made through a search engine that is associated with the e-commerce website. The search engine can usually organize and process all product information relating to online sales and display the processed product information to users (e.g., in response to a search request). However, search engines are typically not optimized to support search of product information of a one-to-many format that involves one product and multiple unit prices. The typical solution for supporting the search of product information of a one-to-many format that involves one product and multiple unit prices is to process a search request for multiple unit prices corresponding to one product on the basis of a database using multiple tables. However, since an e-commerce website typically features a large volume of products for sale, the number of tables in databases that a search engine must search per each search request can be vast, resulting in a slower search speed, lower query accuracy, and generally worse performance.

### BRIEF DESCRIPTION OF THE DRAWINGS

Various embodiments of the invention are disclosed in the following detailed description and the accompanying drawings.

FIG. 1 is a diagram showing an embodiment of a system for performing searches of product information.

FIG. 2 is a flow diagram showing an embodiment of a process for performing searches of product information.

FIG. 3A is a flow diagram showing an embodiment of a process for converting user input product information into a set of preset purchase quantities and corresponding unit prices.

FIG. 3B is a flow diagram showing an embodiment of a process for searching using the converted product information.

FIG. 4 is a diagram showing an embodiment of a system for performing searches of product information.

FIG. 5 is an example of conversion device 301 of system 300.

FIG. 6 is a diagram showing an embodiment of a system for performing searches of product information.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

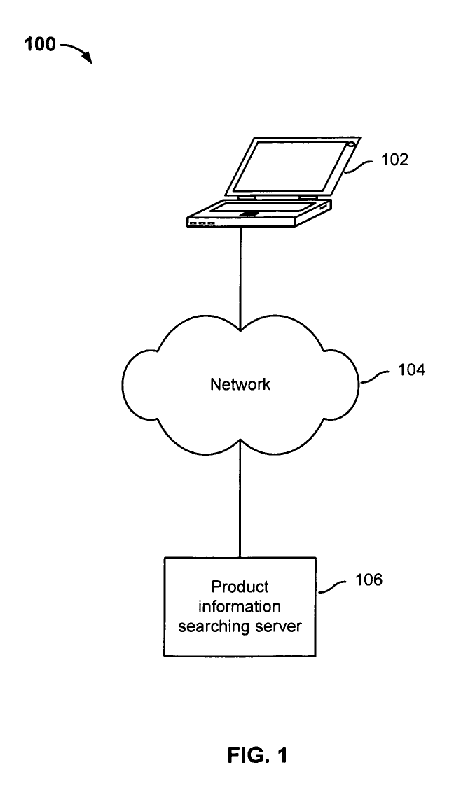

FIG. 1 is a diagram showing an embodiment of a system for performing searches of product information. System 100 includes device 102, network 104, and product information searching server 106. Network 104 can include high speed data and/or telecommunications networks.

Device 102 is configured to access a webpage. In some embodiments, a web browser application is installed on device 102 so that device 102 can access webpages through the web browser application. Examples of device 102 include a desktop computer, a laptop computer, a tablet device, a smart phone, and a mobile device. For example, a user can access an e-commerce website through device 102. At the e-commerce website, a user such as a seller can input/upload information regarding products to be sold at the e-commerce website and a user such as a buyer can search for products to potentially purchase at the e-commerce website.

Product information searching server 106 is configured to convert product information (e.g., input by sellers at an e-commerce website) associated with a product into a set of preset purchase quantities and corresponding unit prices associated with that product. In some embodiments, a seller can input, for a product that he wishes to sell at the e-commerce website, product information such as product name and other product attributes, one or more purchase quantity ranges and corresponding unit prices. In some embodiments, in order to enable more efficient searching through such product information, the one or more user input purchase quantity ranges and corresponding unit prices need to be converted into a set of preset purchase quantities and corresponding unit prices. While different users may input different purchase quantity ranges and corresponding unit prices, by converting each set of user input information into a set of preset purchase quantities and corresponding unit prices (i.e., each preset purchase quantity corresponds to a unit price), all the products can be associated with the same set of preset purchase quantities, though the corresponding unit prices for each set of preset purchase quantities depends on the values of the user input product information. By associating each product with the same set of preset purchase quantities, the unit prices of products at the desired quantity can be searched for based on the preset purchase quantities.

For example, a set of preset purchase quantities (as set by a system administrator) may comprise of 1, 5, 10, and 15 units of a particular product. Each of the 1, 5, 10, 15, and 20 preset purchase quantities is associated with a unit price that is to be determined for each user input product based on the user input product information. A user (e.g., a seller) may input, for example, for a Logitech® computer mouse product that for a purchase quantity range of 1-3, the unit price is $40 and for a purchase quantity range of 4-10, the unit price is $30. Another user (e.g., another seller) may input, for example, for a Microsoft® computer mouse product that for a purchase quantity range of 1-7, the unit price is $30, for a purchase quantity range of 8-12, the unit price is $20, and for a purchase quantity range of 13-18, the unit price is $15. After converting the product information, the Logitech® computer mouse product will be associated with the set preset purchase quantities and the following set of corresponding unit prices: 1 unit: $40, 5 units: $30, 10 units: $30, and 15 units: N/A. After converting the product information, the Microsoft® computer mouse product will be associated with the set preset purchase quantities and the following set of corresponding unit prices: 1 unit: $30, 5 units: $30, 10 units: $20, and 15 units: $15. Thus, if a user (e.g., a buyer) makes a search request for a computer mouse with a desired purchase quantity of 10 units and at a desired unit price range of $10-$20, then using the set of preset purchase quantities for the Logitech® and Microsoft® mice, the Logitech® computer mouse would not be returned as a matching result because its unit price associated with the preset purchase quantity of 10 units is $30, which does not conform to the desired unit price of $10-20. However, the Microsoft® computer mouse would be returned as a matching result because its unit price associated with the preset purchase quantity of 10 units is $20, which does conform to the desired unit price of $10-20.

The set of preset purchase quantities and corresponding unit prices can be stored for each product. One purpose for such a conversion is that there may be inconsistencies in user input purchase quantity ranges (e.g., different users may enter in a different number of purchase quantity ranges and different values for each purchase quantity range) and so converting the user input information for a product into a set of preset purchase quantities can standardize such variety into a set of information that is more easily searchable by a search engine.

Product information searching server 106 is also configured to search through the converted product information (e.g., sets of preset purchase quantities and corresponding unit prices) in response to a search request. For example, the search request can be input at the e-commerce website by a buyer who wishes to buy a product from the website. The search request can include desired product attributes (e.g., product name and product manufacturer of products that the buyer is interested in), desired purchase quantity (e.g., the number of units of each product the buyer desires to purchase during one transaction), and desired unit price (e.g., how much a buyer is willing to pay for each unit of each product at the desired purchase quantity). In some embodiments, a preset purchase quantity is determined based on the desired purchase quantity. For example, assume that the set of preset purchase quantities that is associated with each product includes: 1 unit, 5 units, 10 units, and 15 units. If a desired purchase quantity is 12 units, then a preset purchase quantity for this desired purchase quantity can be determined based on a predetermined rule. If the predetermined rule were to choose a preset purchase quantity that is closest in value to the value of the desired purchase quantity, then the preset purchase quantity of 10 units can be determined (because it is the closest to the desired 12 units of the preset purchase quantities of 1, 5, 10, and 15 units). In some embodiments, a query is generated based on the determined preset purchase quantity and the desired unit price. Then the database(s) that store converted product information can be searched using the generated search query for products with unit prices at the determined preset purchase quantity that correspond with the desired unit price. For example, if in the generated query, the determined preset purchase quantity is 10 units and the desired unit price of the search request were $15-20, then the database(s) would be searched for products which at the preset purchase quantity of 10 units correspond to a unit price that is in the unit price range of $15-20. In some embodiments, matching products are returned among the search results for the searching user.

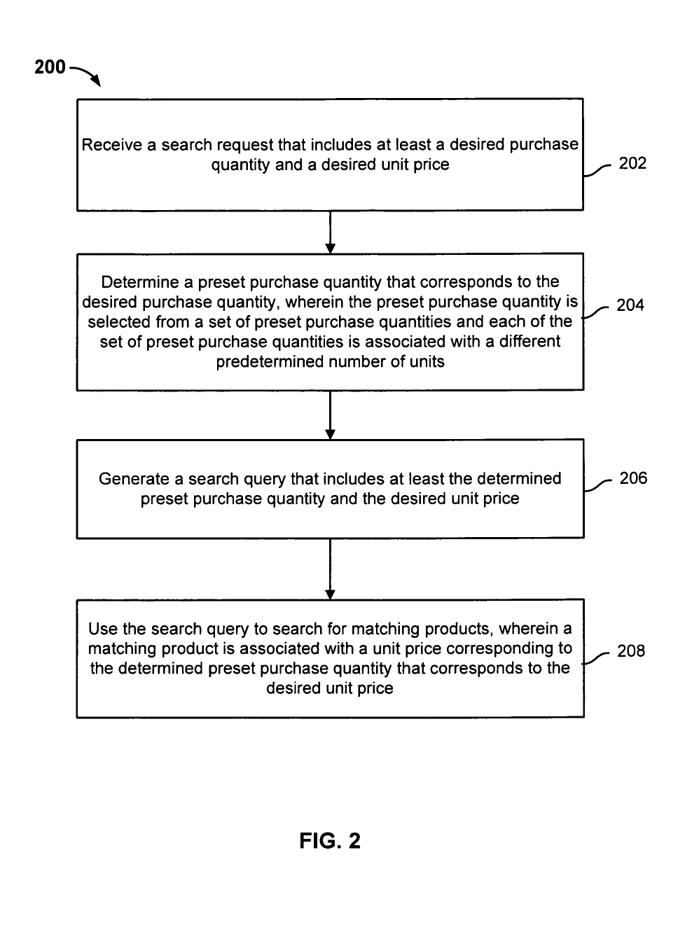

FIG. 2 is a flow diagram showing an embodiment of a process for performing searches of product information. In some embodiments, process 200 can be performed on system 100.

At 202, a search request that includes at least a desired purchase quantity and a desired unit price is received. In some embodiments, the search request is submitted at an e-commerce website by a user (e.g., an e-commerce buyer). In some embodiments, the search request is for products that are available at the e-commerce website. In some embodiments, a search request can include, for example, desired product attributes (e.g., product name and product manufacturer of products that the buyer is interested in), desired purchase quantity (e.g., the number of units of each product the buyer desires to purchase during one transaction), and desired unit price (e.g., how much a buyer is willing to pay for each unit of each product at the desired purchase quantity).

In some embodiments, a user submits a search request at a web browser-based interface of the e-commerce website (e.g., supported by a front-end system of the website). The search request interface can include, for example, an input window and/or one or more interactive elements (e.g., drop down menus, radio buttons, checkboxes) that are configured for the user to select for generating the desired product attributes, desired purchase quantity, desired unit price, among others. The generated (at least) desired product attributes, desired purchase quantity, and desired unit price are used to match against converted user inputted product information and those that match the desired product attributes, desired purchase quantity, and desired unit price of a search request are returned to the searching user as search results. In some embodiments, the search request can include keywords associated with products (e.g., product titles, product attributes such as product manufacturers/models, industries associated with the product, geographic locations associated with products). In some embodiments, the desired purchase quantity is the amount of each product for which the user is searching and that the user desires/plans to purchase in one transaction. The desired purchase quantity can be a whole number value that is greater than zero. In some embodiments, the desired unit price may be a range of unit prices or one specific unit price value.

At 204, a preset purchase quantity that corresponds to the desired purchase quantity is determined, wherein the determined preset purchase quantity is selected from a set of preset purchase quantities and each of the set of preset purchase quantities is associated with a different predetermined number of units.

In various embodiments, the respective information associated with a product that is submitted by a user (e.g., a seller of that product) at the e-commerce website is converted. For example, the submitted product information can include a product identifier (e.g., “product A”) and one or more purchase quantities and corresponding unit prices as set by the seller of product A. For the same or different product, another seller can submit product information with an identifier and another one or more purchase quantities and corresponding unit prices. The user input purchase quantities and corresponding unit prices can be converted into a set of preset purchase quantities and corresponding unit prices, as explained in further detail below. Each of the set of preset purchase quantities is associated with a different value that represents a different number of units of the particular product with which the set of preset purchase quantities is associated. In some embodiments, the value of each in the set of preset purchase quantities is configured by a system administrator. The associated set of preset quantities and corresponding unit prices can be stored (e.g., at a table at a database) for each product that is input at the e-commerce website by a user. In some embodiments, even if the same product is input by two or more different sellers, each instance of the product is considered to be a separate product that is each converted into a set of preset purchase quantities and corresponding unit prices based on the user input product information that is relevant to that instance of the product. Put another way, after conversion, a product that is sold by a particular seller is associated with a set of preset purchase quantities (and the same set of preset purchase quantities is associated with every other product at the system, even different instances of the same product) and corresponding unit prices that are based on the user input product information. In some embodiments, all products that are each associated with more than one unit price (e.g., a product A sold by seller Alice with product information that indicates the unit price is $10 if 1-5 units are purchased in one transaction and the unit price is $8 if 6-10 units are purchased in one transaction) are converted in this manner such that after conversion, each product is associated with the same set of preset purchase quantities but possibly different corresponding unit prices for each set of purchase quantities.

In some embodiments, based on predetermined rules, a preset purchase quantity is determined for the desired purchase quantity. For example, a predetermined rule can be that the preset purchase quantity with a value that is closest to the value of the desired purchase quantity is chosen.

At 206, a search query that includes at least the determined preset purchase quantity and the desired unit price is generated.

In some embodiments, once the preset purchase quantity is determined, a search query can be generated to search for products at the e-commerce website that match the user's original search request.

At 208, the search query is used to search for matching products, wherein a matching product is associated with a unit price corresponding to the determined preset purchase quantity that corresponds to the desired unit price.

In some embodiments, the generated search query is used to search through one or more databases that store data related to products that are available at the e-commerce website. For example, for each product, among other data, its product attributes (e.g., product manufacturer, product model) and set of unit prices corresponding to the set of preset purchase quantities (e.g., determined after the conversion process) can be stored. The search query can be used to search for matching products for which the unit price associated with the determined preset purchase quantity corresponds to the desired unit price. For example, assuming that the desired unit price was a range of values, then a unit price of a product at the determined preset purchase quantity corresponds to the desired unit price if value of the unit price falls within the range of values of the desired unit price. Also for example, assuming that the desired unit price was a specific value, then a unit price of a product at the determined preset purchase quantity matches the desired unit price if the value of the unit price were the same as the value of the desired unit price.

In some embodiments, in addition to the desired unit price at the determined preset purchase quantity, the search query also includes one or more desired product attributes of the user's original search request. In some embodiments, in order for a matching product to be found, in addition to having the product's associated unit price at the determined preset purchase quantity correspond to the desired unit price, one or more attributes of the product must also match one or more desired attributes included in the search query.

Converting user input product information associated with a product into a set of preset purchase quantities and corresponding unit prices for that product is disclosed. In some embodiments, a seller inputs at a user interface associated with an e-commerce website information related to a product that he wishes to sell. In some embodiments, the input product information is stored. In some embodiments, the product information includes one or more product attributes (e.g., product manufacturer, product model, product name). In various embodiments, the product information also includes one or more user input purchase quantity ranges and the unit price at each such corresponding purchase quantity range.

In some embodiments, the first step in converting user input product information for a product is to match each preset purchase quantity with a user input purchase quantity range associated with that product. In some embodiments, the second step in converting user input product information for a product is to establish corresponding relationships between the preset purchase quantities that matched the user input purchase quantity ranges and user input unit prices of the matched user input purchase quantity ranges.

The following example will be used to explain the converting process:

In this example, for a certain product, an e-commerce seller has input (e.g., uploaded to the e-commerce website) the following product information: product title, product photos, product description, product attributes, shipping fees, product prices, among others. Within product prices, there are unit prices that correspond to various purchase quantity ranges determined and input by the seller. In various embodiments, both user input purchase quantities and preset purchase quantities are generally inversely related to their corresponding unit prices. That is, the smaller the amount of the purchase order quantity (i.e., the number of units of a product to buy in one transaction), the higher the corresponding unit price and the larger the purchase order quantity, the lower the corresponding unit price.

In this example, the product prices for the product of “mp4” that is input by e-commerce seller A are shown in Table 1:

TABLE 1

| Purchase quantity range | Purchase quantity range | |
|---|---|---|
| lower limit (number of | upper limit (number of | Unit price |
| units) | units) | (US dollars) |
| 1 | 3 | 100 |
| 4 | 8 | 95 |
| 9 | 20 | 90 |
| 21 | 50 | 85 |
| 51 | 80 | 80 |

The product prices for the same product of “mp4” that is input by e-commerce seller B are shown in Table 2:

TABLE 2

| Purchase quantity range | Purchase quantity range | |
|---|---|---|
| lower limit (number of | upper limit (number of | Unit price |
| units) | units) | (US dollars) |
| 1 | 3 | 60 |
| 4 | 8 | 55 |
| 9 | 20 | 45 |
| 21 | 50 | 40 |
| 51 | 80 | 35 |

While in this example, each product is associated with only five user input purchase quantity ranges and corresponding unit prices, a product may be associated with more or fewer user input purchase quantity ranges and corresponding unit prices in actual implementation. Also, a user may input different purchase quantity ranges other than the ones shown in the example.

In various embodiments, a table (e.g., in a database) used to store converted product information includes at least as many fields for unit prices as there are preset purchase quantities. In various embodiments, a system administrator configures each preset purchase quantity that is to be associated with each product. In various embodiments, the system administrator configures at least two or more preset purchase quantities (which, in some embodiments, is referred to as a set of N preset purchase quantities) to be associated with each product. In some embodiments, the values of preset purchase quantities are configured based on statistical analyses of purchase quantities from historical records of purchases made by e-commerce buyers at e-commerce websites. For example, the value of each of the N preset purchase quantities can be chosen to be as close as possible to the quantities (e.g., number of units) of purchases historically made by the great majority of e-commerce website buyers. In some embodiments, the specific values of preset purchase quantities may be adjusted on the basis of statistical analyses. For each preset purchase quantity, a corresponding unit price field is set up in the table in which the converted product information is to be stored. Once the user input purchase quantity ranges are converted into preset purchase quantities for a product, the corresponding unit prices can be determined for the product, to complete the product information conversion process. In some embodiments, the product information can be converted subsequent to a user inputting product information at the e-commerce website. By converting user input purchase quantity ranges and corresponding unit prices, which is a one-to-many relationship between a product and its purchase order ranges, into a set of preset purchase quantities and a corresponding set of unit prices, a one-to-one relationship may be established for a product and each preset purchase quantity and its corresponding unit price.

For example, the number of preset purchase quantities is set to 10, which means there are also 10 corresponding unit prices (one unit price corresponding to each of the 10 preset purchase quantities). In this example, the identifier of each unit price field is the unit price identifier followed by a unique number, though each unit price field can be identified by any other convention. The identifiers of the unit price fields in this example are price1, price2, price3, . . . , price10.

In this example, the table used to store converted product information can contain the following fields: product name, product picture, product description, product attribute, price1, price2, price3, . . . , price10, etc.

Furthermore, a reference table for storing preset purchase quantities and their corresponding unit price identifiers can be added to the database, such as shown in the example of Table 3:

TABLE 3

| Identifiers of unit price | Preset purchase quantity |
|---|---|
| price1 | 1 |
| price2 | 2 |
| price3 | 3 |
| price4 | 5 |
| price5 | 8 |
| price6 | 10 |
| price7 | 20 |
| price8 | 30 |
| price9 | 50 |
| price10 | 100 |

As shown in the example of Table 3, by using a reference table in the database, corresponding relationships can be established between the preset purchase quantities and the unit prices. Since the size of data required to store the corresponding relationships between the preset purchase quantities and the unit prices is small, they can be written directly into a program associated with a search engine that is configured to search through the converted product information.

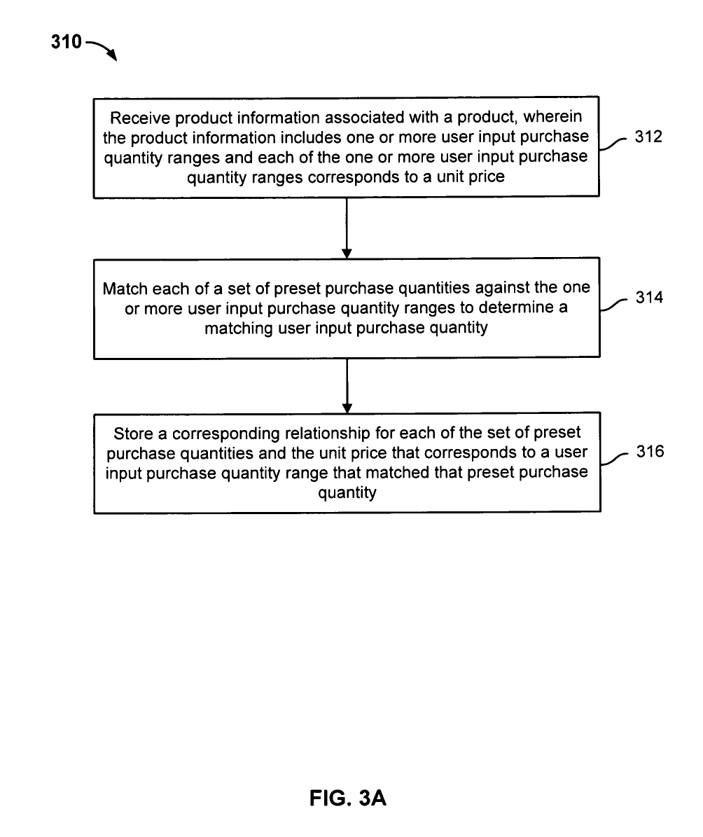

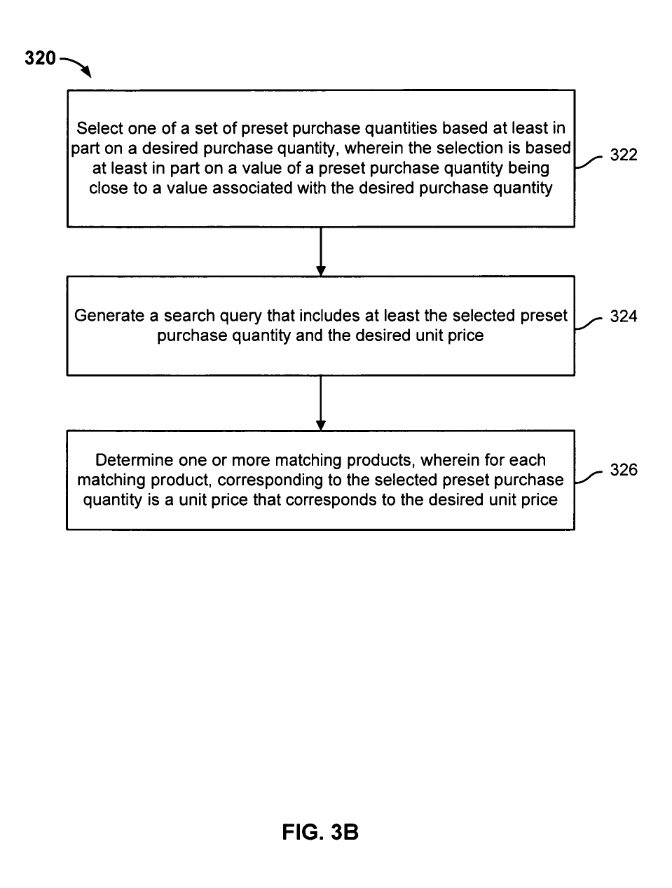

FIG. 3A is a flow diagram showing an embodiment of a process for converting user input product information into a set of preset purchase quantities and corresponding unit prices. In some embodiments, process 310 can be implemented on system 100. In some embodiments, process 310 is implemented for each product for which product information is input at the e-commerce website.

At 312, product information associated with a product is received, wherein the product information includes one or more user input purchase quantity ranges and each of the one or more user input purchase quantity ranges corresponds to a unit price. For example, the product information associated with a product is input by a seller at the e-commerce website. In this example, the user input purchase quantity ranges and corresponding user input unit price for the product includes: for a purchase quantity range of 1-3, the unit price is $40 and for a purchase quantity range of 4-10, the unit price is $30.

At 314, each of a set of preset purchase quantities is matched against the one or more user input purchase quantity ranges to determine a matching user input purchase quantity range. For example, if the set of preset purchase quantities comprises 1 unit, 5 units, 10 units, and 15 units, then each of the 1 unit, 5 units, 10 units, and 15 units would be matched against each of the user input purchase quantity ranges (for a purchase quantity range of 1-3, the unit price is $40 and for a purchase quantity range of 4-10, the unit price is $30). A preset purchase quantity can match a user input purchase quantity range if the value of the preset purchase quantity is greater than or equal to the lower limit associated with the user input purchase quantity range and equal to or less than the upper limit associated with the user input purchase quantity range. So, the preset purchase quantity of 1 unit would match the user input purchase quantity range of 1-3, the preset purchase quantity of 5 units would match the user input purchase quantity range of 4-10, the preset purchase quantity of 10 units would match the user input purchase quantity range of 4-10, and the preset purchase quantity of 15 units would not match any of the user input purchase quantity ranges.

At 316, a corresponding relationship is stored for each of the set of preset purchase quantities and the unit price that corresponds to a user input purchase quantity range that matched that preset purchase quantity. Returning to the above example, because the preset purchase quantity of 1 unit matched the user input purchase quantity range of 1-3, a relationship is stored between preset purchase quantity of 1 unit and the unit price of $40 (the unit price that corresponds to the user input purchase quantity range of 1-3). Similarly, a relationship is stored for the preset purchase quantity of 5 units that matched the user input purchase quantity range of 4-10 and the unit price of $30, the unit price that corresponds to the user input purchase quantity range of 4-10. Next, a relationship is stored for the preset purchase quantity of 10 units that matched the user input purchase quantity range of 4-10 and the unit price of $30, the unit price that corresponds to the user input purchase quantity range of 4-10. Lastly, a relationship is stored between the preset purchase quantity of 15 units that did not match any of the user input purchase quantity ranges and a preset value to indicate a lack of a match.

An example of a conversion rule for matching preset purchase quantities to user input purchase quantity ranges for a product is as follows (the following operation is performed for each preset purchase quantity):

Match the current preset purchase quantity to each user input purchase quantity range associated with the product. An example matching technique is as follows:

If the value of the preset purchase quantity is greater than or equal to the value of the purchase quantity range lower limit of a user input purchase quantity range and is less than or equal to the value of the purchase quantity range upper limit of a purchase quantity range, then the match is successful/made.

As a result of a match being made between a particular user input purchase quantity range and a preset purchase quantity, a correspondence is thus established between the current preset purchase quantity and the unit price corresponding to the matched user input purchase quantity range.

If no match is found between a user input purchase quantity range and a preset purchase quantity, in some embodiments, a correspondence is established between the current preset purchase quantity and a preset unit price. The preset unit price can be set to a negative value, for example, “−1,” to indicate that there is no match found between that preset purchase quantity and a user input purchase quantity range. In some embodiments, the preset unit price can satisfy an inverse relation between the increase of preset purchase quantities and the corresponding decrease of unit prices. In some embodiments, a preset unit price is not included in the converted table if a match is not found.

The following is an example of applying the matching technique as explained above for the product information “mp4” in Table 1 that was input by seller A:

Referring to Table 3, the preset purchase quantity corresponding to the unit price field “price1” is “1.” Comparing the preset purchase quantity of “1” to each of the user input purchase quantity ranges, a range is matched where the user input purchase quantity range lower limit is less than or equal to the preset purchase quantity “1” and the user input purchase quantity range upper limit is greater than or equal to the preset purchase quantity “1.” Thus, the first range [1, 3] is matched to this preset purchase quantity of “1.” Therefore, for the product “mp4” that is input by e-commerce seller A, the value of the unit price field price1 in Table 3 should be populated with the unit price “100,” which is the unit price that corresponds to the matching first range, as shown in Table 1. Thus, a corresponding relationship is established between the current preset purchase quantity “1” and the unit price “100” that corresponds to the matched first range.

Referring to Table 3, the “preset purchase quantity” corresponding to the unit price field “price2” is “2.” Comparing the preset purchase quantity of “2” to each of the user input purchase quantity ranges, a range is matched where the user input purchase quantity range lower limit is less than or equal to the preset purchase quantity “2” and the user input purchase quantity range upper limit is greater than or equal to the preset purchase quantity “2.” Thus, the first range [1, 3] is found to match again. Therefore, for the product “mp4” that is input by e-commerce seller A, the value of the unit price field price2 in Table 3 should be populated with the unit price “100,” which is the unit price that corresponds to the matching first range, as shown in Table 1. Thus, a corresponding relationship is established between the current preset purchase quantity “2” and the unit price “100” that corresponds to the matched first range.

Referring to Table 3, skipping ahead a few preset purchase quantities, the “preset purchase quantity” corresponding to the unit price field “price5” is “8.” Comparing the preset purchase quantity of “8” to each of the user input purchase quantity ranges, a range is matched where the user input purchase quantity range lower limit is less than or equal to the preset purchase quantity “8” and the user input purchase quantity range upper limit is greater than or equal to the preset purchase quantity “8.” Thus, the second range [4, 8] is matched. Therefore, for the product “mp4” input by e-commerce seller A, the value of the unit price field price5 in Table 3 should be populated with the unit price “95,” which is the unit price that corresponds to the matching second range, as shown in Table 1. Thus, a corresponding relationship is established between the current preset purchase quantity “8” and the unit price “95” that corresponds to the matched second range.

Referring to Table 3, skipping ahead a few preset purchase quantities, “preset purchase quantity” corresponding to the unit price field “price10” is “100.” Comparing the preset purchase quantity of “100” to each of the user input purchase quantity ranges, a range is matched where the user input purchase quantity range lower limit is less than or equal to the preset purchase quantity “100” and the user input purchase quantity range upper limit is greater than or equal to the preset purchase quantity “100.” Thus, there is no range that can be matched to this preset purchase quantity. Therefore, the value in the database product table of the unit price field price10 in Table 3 can be set to the preset unit price “−1.” Thus, a corresponding relationship is established between the current preset purchase quantity “100” and the preset unit of price “−1.”

After performing matching for each preset purchase quantity, the unit prices corresponding to the unit price fields price1 through price10 are stored in a table at the database for the product “mp4” inputted by e-commerce seller A. The table used to store corresponding relationships between preset purchase quantities and unit prices can include a column with the identifiers of the unit prices that correspond to the preset purchase quantities and another column with the corresponding values of the unit prices One example of such a table is Table 4:

TABLE 4

| Identifier of unit price field | Value of unit price field |
|---|---|
| (unit price identifier) | (unit price in US Dollars) |
| price1 | 100 |
| price2 | 100 |
| price3 | 100 |
| price4 | 95 |
| price5 | 95 |
| price6 | 90 |
| price7 | 90 |
| price8 | 85 |
| price9 | 85 |
| price10 | −1 |

The example described above is just one example of a table that can be used to store the corresponding relationships between preset purchase quantities (each of which can be identified by the identifier of a corresponding unit price field) and the unit prices of matching user input purchase quantity ranges. In another example, a table used to store corresponding relationships between preset purchase quantities and unit prices for each product can include a column with the values of the preset purchase quantities and another column with the corresponding values of the unit prices. An example of such a table is Table 5:

TABLE 5

| Preset purchase quantity | |
|---|---|
| (number of units) | Unit price in US Dollars |
| 1 | 100 |
| 2 | 100 |
| 3 | 100 |
| 5 | 95 |
| 8 | 95 |
| 10 | 90 |
| 20 | 90 |
| 30 | 85 |
| 50 | 85 |
| 100 | −1 |

For further clarity, the following is an example of applying the matching technique as explained above for the product information “mp4” in Table 2 that was input by seller B:

Referring to Table 3, the “preset purchase quantity” corresponding to the unit price field “price1” is “1.” Comparing the preset purchase quantity of “1” to each of the user input purchase quantity ranges, a range is matched where the user input purchase quantity range lower limit is less than or equal to the preset purchase quantity “1” and the user input purchase quantity range upper limit is greater than or equal to the preset purchase quantity “1.” Thus, the first range [1, 3] is matched to this present purchase quantity of “1.” Therefore, for the product “mp4” that is input by e-commerce seller B, the value of the unit price field price1 in Table 3 should be populated with the unit price “60,” which is the unit price that corresponds to the matching first range, as shown in Table 2. Thus, a corresponding relationship is established between the current preset purchase quantity “1” and the unit price “60” that corresponds to the matched first range.

Referring to Table 3, skipping ahead a few preset purchase quantities, the “preset purchase quantity” corresponding to the unit price field “price6” is “10.” Comparing the preset purchase quantity of “10” to each of the user input purchase quantity ranges, a range is matched where the user input purchase quantity range lower limit is less than or equal to the preset purchase quantity “10” and the user input purchase quantity range upper limit is greater than or equal to the preset purchase quantity “10.” Thus, the third range [9, 20] is matched. Therefore, for the product “mp4” input by e-commerce seller B, the value of the unit price field price6 in Table 3 should be populated with the unit price “45,” which is the unit price that corresponds to the matching third range, as shown in Table 2. Thus, a correspondence is established between the current preset purchase quantity “10” and the unit price “45” that corresponds to the matched third range.

Referring to Table 3, skipping ahead a few preset purchase quantities, the “preset purchase quantity” corresponding to the unit price field “price10” is “100.” Comparing the preset purchase quantity of “100” to each of the user input purchase quantity ranges, a range is matched where the user input purchase quantity range lower limit is less than or equal to the preset purchase quantity “100” and the user input purchase quantity range upper limit is greater than or equal to the preset purchase quantity “100.” Thus, there is no range that can be matched to this preset purchase quantity. Therefore, the value in the database product table of the unit price field price10 in Table 3 can be set to the preset unit price “−1.” Thus, a corresponding relationship is established between the current preset purchase quantity “100” and the preset unit price of “−1.”

After performing matching for each preset purchase quantity, the unit prices corresponding to the unit price fields price1 through price10 are stored in a table at the database for the product “mp4” inputted by e-commerce seller B. The table used to store corresponding relationships between preset purchase quantities and unit prices can include a column with the identifiers of the unit prices that correspond to the preset purchase quantities and another column with the corresponding values of the unit prices One example of such a table is Table 6:

TABLE 6

| Identifier of unit price field | Value of unit price field |
|---|---|
| (unit price identifier) | (unit price in US Dollars) |
| price1 | 60 |
| price2 | 60 |
| price3 | 60 |
| price4 | 55 |
| price5 | 55 |
| price6 | 45 |
| price7 | 45 |
| price8 | 40 |
| price9 | 40 |
| price10 | −1 |

After converting product information for all products input by sellers for which conversion is appropriate, the resultant information (i.e., set of preset purchase quantities and corresponding set of unit prices) for each product can be stored at the database(s) so that such data can be used by a search engine.

FIG. 3B is a flow diagram showing an embodiment of a process for searching using the converted product information. In some embodiments, process 320 can be implemented o system 100. In some embodiments, process 320 is used to implement 204, 206, and 208 of process 200.

At 322, one of a set of preset purchase quantities is selected based at least in part on a desired purchase quantity, wherein the selection is based at least in part on a value of a preset purchase quantity being close to a value associated with the desired purchase quantity.

In some embodiments, the first step of a search engine's search through converted product information is to determine a preset purchase quantity (one among the set of preset purchase quantities that has been associated with each product by a process such as process 310) based on the desired purchase quantity of the original user request. In some embodiments, the user input purchase quantity ranges of each product are converted into a standard set of preset purchase quantities so all products whose information have been converted are associated with the same set of purchase quantities. In some embodiments, the determined preset purchase quantity can be the preset purchase quantity that has the closest value to that of the desired purchase quantity.

The following is an example of how to determine which preset purchase quantity has the closest value to the desired purchase quantity:

If there is a preset purchase quantity that has the same value as the value of the desired purchase quantity or has the closest value to the value of the desired purchase quantity, then this preset purchase quantity will be the determined preset purchase quantity.

If there are two preset purchase quantities that have values that are equally close to the planned purchase quantity, then the preset purchase quantity with the smaller value is chosen to be the determined preset purchase quantity.

In some embodiments, the search engine can generate a product information index based on the corresponding relationships between each product's preset purchase quantities and unit prices. For example, the search engine can periodically download data from the database(s) where the preset purchase quantities and corresponding unit prices of products are stored, used to generate the product information index. For example, the search engine can download data from the database(s) once every hour.

In some embodiments, the corresponding relationships between a product's preset purchase quantities and unit prices are stored using unit price identifiers. For example, for the price of product “mp4” that is by e-commerce seller A in Table 1, the corresponding relationship between the preset purchase quantity “5” and the unit price “95” is established through using the purchase quantity identifier of “price4,” and the corresponding relationship between the preset purchase quantity “10” and the unit price “90” is established through the unit price identifier “price6,” and so on. If, for each product, the unit price identifier is stored with the corresponding unit price values, then a table that associates the unit price identifiers with the values of the corresponding preset purchase quantities can be consulted to determine the associations between preset purchase quantities and corresponding unit prices.

At 324, a search query that includes at least the selected preset purchase quantity and the desired unit price is generated.

In some embodiments, the second step of a search engine's search through converted product information is to create a search query based on the preset purchase quantity determined in the first step and the desired unit price of the original search request. In some embodiments, the search query also includes one or more product attributes from the original search request.

At 326, one or more matching products are determined, wherein for each matching product, corresponding to the selected preset purchase quantity is a unit price associated that corresponds to the desired unit price.

In some embodiments, the search query can be used to search for matching products at the database(s) that store converted product information (i.e., the corresponding relationships between preset purchase quantities and unit prices for each product). In some embodiments, the search query can be used to search for matching products using a program associated with the search engine that stores the corresponding relationships between the preset purchase quantities and corresponding unit prices for each product. In some embodiments, a product that matches the search query can be a product that is associated with a unit price corresponding to the determined preset purchase quantity that corresponds to the desired unit price. For example, if the desired unit price were a single value, then the value of the unit price of the matching product at the determined purchase quantity would need to be equal to the value of the desired unit price. Or, for example, if the desired unit price were a range of values, then the value of the unit price of the matching product at the determined purchase quantity would need to be within the range of the range of values of the desired unit price.

In some embodiments, in order to be a matching product, in addition to matching the search query's desired unit price corresponding to the determined purchase quantity, the product must also match the one or more product attributes included in the search query. For example, the same database(s) that are used to store the converted product information for each product can also store product attributes related to those products. Examples of product attributes can include manufacturer, model, brand, name, date of release, and specifications.

For example, an e-commerce buyer inputs through a client-side browser the following product information to be included in a search request: product attribute: “mp4,” desired purchase quantity: “10,” and desired unit price: “25” to “50.”

In this example, the preset purchase quantities (i.e., “1,” “2,” “3,” “5,” “8,” “10,” “20,” “30,” “50,” and “100”) of Table 3 apply. The preset purchase quantity of “10” is then determined to be the closest to the desired purchase quantity of “10.” Referring to a reference table such as Table 3, the unit price identifier corresponding to the determined preset purchase quantity of “10” is “price6.” Therefore, a query is made by the search engine for product information that matches product attribute “mp4” and with a unit price field identifier of “price6” whose value is greater than or equal to “25” and less than or equal to “50” (i.e., within the range of the desired unit price). A product that matches the query will be included in the search results.

Returning to the examples of the product information for the products “mp4” provided by the e-commerce sellers A and B: For the product “mp4” input by e-commerce seller A, the value of the unit price field “price6” is “90” so it does not comply with the desired unit price of greater than or equal to “25” and less than or equal to “50.” Therefore, product “mp4” that is sold by seller A is not included in the search results. But for the product “mp4” input by e-commerce seller B, the value of the unit price field “price6” is “45” and it does comply with the desired unit price of greater than or equal to “25” and less than or equal to “50.” Therefore, product “mp4” sold by seller B is included in the search results.

In the search examples given above, first, the appropriate preset purchase quantity is determined based on the desired purchase quantity. Then, a search is performed using the determined preset purchase quantity and the desired price unit/one or more product attributes. Although in some embodiments, first, products that match the one or more product attributes of the original search request are determined. Then, the appropriate preset purchase quantity is determined and a search is performed among those products that match the one or more product attributes for the subset of products that also match the desired unit price corresponding to the determined preset purchase quantity.

For example, an e-commerce buyer inputs through a client-side browser the following product information to be included in a search request: product attribute: “mp4,” desired purchase quantity: “25,” and desired unit price: “25” to “50.”

In the example, the desired purchase quantity of “25” is equally close to both preset purchase quantities of “20” and “30.” Assume that the rule that if there are two preset purchase quantities that are equally close to the desired purchase quantity, then the preset purchase quantity that is the smaller of the two is chosen. Then the determined preset purchase quantity in this example is “20.” The unit price identifier corresponding to the determined preset purchase quantity of “20” is “price7.” Therefore, in the product information index, a search query is made for product information that matches with the product attribute of “mp4” and with a unit price field “price7” and whose value is greater than or equal to “25” and less than or equal to “50” (i.e., the desired unit price range is “25” to “50”). Returning to the examples of the product information for the products “mp4” provided by the e-commerce sellers A and B: For the product “mp4” input by e-commerce seller A, the value of the unit price field “price7” is “90” so it does not match with the desired unit price of greater than or equal to “25” and less than or equal to “50.” Therefore, product “mp4” sold by seller A is not included in the search results. But for the product “mp4” input by e-commerce seller B, because the value of the unit price field “price7” is “45,” it does match with the desired unit price of greater than or equal to “25” and less than or equal to “50.” Therefore, product “mp4” sold by seller B is included in the search results.

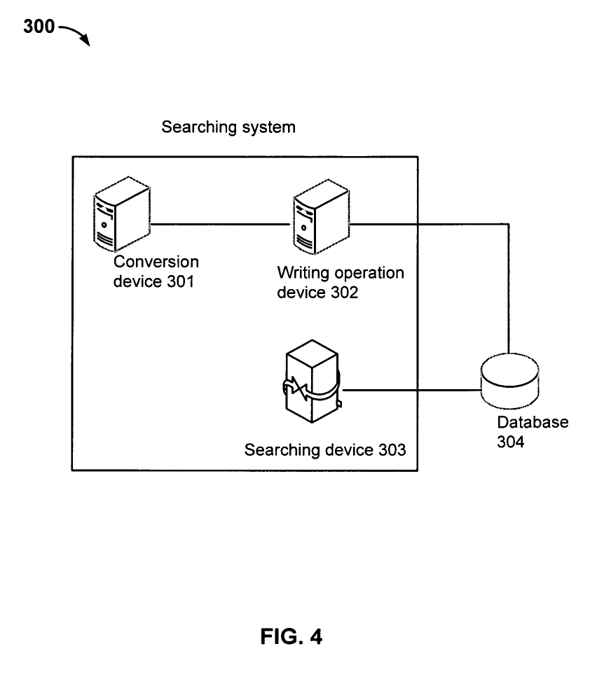

FIG. 4 is a diagram showing an embodiment of a system for performing searches of product information. In the example, system 300 includes: conversion device 301, writing operation device 302, a searching device 303, and database 304.

The devices can be implemented as software components executing on one or more processors, as hardware such as programmable logic devices and/or Application Specific Integrated Circuits designed to perform certain functions or a combination thereof. In some embodiments, the devices can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention.

Conversion device 301 is configured to convert, for each product, product information including user input purchase quantity ranges and corresponding unit prices into a set of preset purchase quantities and corresponding unit prices.

Writing operation device 302 is configured to store the corresponding relationships of each product's preset purchase quantities and its unit prices, which were obtained by the conversions performed by conversion device 301. In some embodiments, writing operation device 302 stores the corresponding relationships for products in tables at one or more databases.

Searching device 303 is configured to receive search requests that include product attributes, desired purchase quantity, and desired unit price, among others. A preset purchase quantity is determined based on the desired purchase quantity. Then, a search query is generated based at least in part on the determined preset purchase quantity and desired unit price and/or one or more product attributes. The search query is used to find matching products from the database, where a matching product is one that is at least associated with a unit price corresponding to the determined preset purchase quantity that corresponds to the desired unit price. In some embodiments, the matching product must also match at least one of one or more product attributes of the original search request.

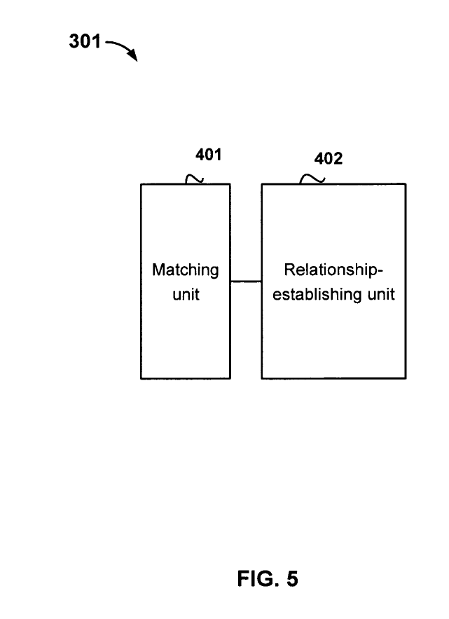

FIG. 5 is an example of conversion device 301 of system 300.

In the example, conversion device 301 includes a matching unit 401 and a relationship-establishing unit 402. The units can be implemented as software components executing on one or more processors, as hardware such as programmable logic devices and/or Application Specific Integrated Circuits designed to perform certain functions, or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices.

Matching unit 401 is configured to determine a match, if any, between each of a set of preset purchase quantities and a user input purchase quantity range for a product. For example, it is determined that a preset purchase quantity matches a user input purchase quantity range if the preset purchase quantity is greater than or equal to the lower limit of the user input purchase quantity and also less than or equal to the upper limit of the user input purchase quantity.

Relationship-establishing unit 402 is configured to store corresponding relationships between the preset purchase quantities and the unit prices corresponding to the user input purchase quantity ranges matched by matching unit 402.

In some embodiments, relationship-establishing unit 402 is configured to store a corresponding relationship between a preset purchase quantity and a preset unit price if the preset purchase quantity is determined to not match any user input purchase quantity ranges of a product.

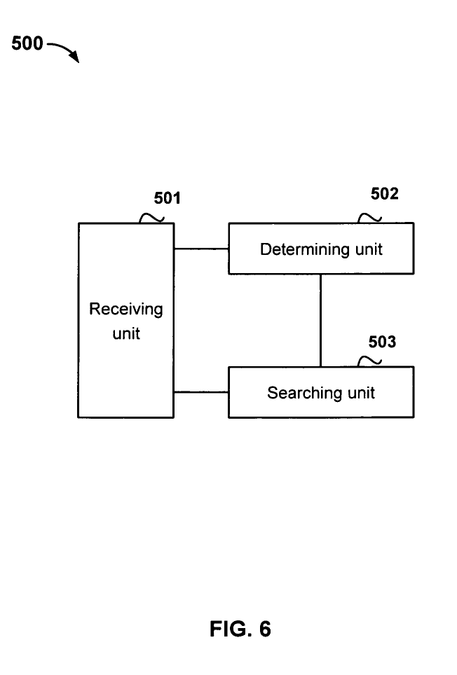

FIG. 6 is a diagram showing an embodiment of a system for performing searches of product information. System 500 includes receiving unit 501, determining unit 502, and searching unit 503.

Receiving unit 501 is configured to receive product information search requests. In some embodiments, search requests include product attributes, desired purchase quantities, and desired unit prices.

Determining unit 502 is configured to determine a preset purchase quantity based on the desired purchase quantity of a search request. For example, the preset purchase quantity can be chosen to be the one that is the closest to the desired purchase quantity and if there are two preset purchase quantities that are equally chose to the desired purchase quantity, then the preset purchase quantity whose value is smaller is chosen.

Searching unit 503 is configured to generate a search query that includes at least the determined preset purchase quantity and the desired unit price and/or one or more product attributes from the search request. Searching unit 503 is also configured to use the search query to search for matching products for which information is stored at one or more databases. In some embodiments, a matching product is one whose unit price corresponding to the determined preset purchase quantity corresponds to the desired unit price and, in some embodiments, also matches one or more product attributes of the search query.

A person skilled in the art should understand that the embodiments of the present application can be provided as methods, devices, or computer software products. Therefore, the present application may make use of embodiments that are entirely hardware or software or embodiments that are combinations of hardware and software. In addition, the present application can take the form of computer programs implemented on one or more computer-operable storage media (including but not limited to magnetic disk storage devices, CD-ROMs, and optical storage devices) containing computer program codes.

The present application is described with reference to flow charts and/or block diagrams based on methods, devices and computer program products of embodiments of the present application. It should be understood that each process and/or block in the flow charts and/or block diagrams, and combinations of processes and/or blocks in the flow charts and/or block diagrams, can be achieved through computer program commands. One can provide these computer commands to a general-purpose computer, a specialized computer, an embedded processor or the processor of other programmable data equipment so as to give rise to a machine, with the result that the commands executed through the computer or processor of other programmable data equipment give rise to a device that is used to realize the functions designated by one or more processes in a flow chart and/or one or more blocks in a block diagram.

These computer program commands can also be stored on specially-operating computer readable storage devices that can guide computers or other programmable data equipment, with the result that the commands stored on these computer readable devices give rise to products that include command devices. These command devices realize the functions designated in one or more processes in a flow chart and/or one or more blocks in a block diagram.

These computer program commands can also be loaded onto a computer or other programmable data equipment, with the result that a series of operating steps are executed on a computer or other programmable equipment so as to give rise to computer processing. In this way, the commands executed on a computer or other programmable equipment provide steps for realizing the functions designated by one or more processes in a flow chart and/or one or more blocks in a block diagram.

Although preferred embodiments of the present application have already been described, a person skilled in the art can make other modifications or revisions to these embodiments once he grasps the basic creative concept. Therefore, the attached claims are to be interpreted as including the preferred embodiments as well as all modifications and revisions falling within the scope of the present application.

A person skilled in the art can modify and vary the present application without departing from the spirit and scope of the present invention. Thus, if these modifications to and variations of the present application lie within the scope of its claims and equivalent technologies, then the present application intends to cover these modifications and variations as well.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of searching product information, comprising:
receiving a search request that includes at least a desired purchase quantity and a desired unit price;
determining a preset purchase quantity that corresponds to the desired purchase quantity, wherein the determined preset purchase quantity is selected from a set of preset purchase quantities and each of the set of preset purchase quantities is associated with a different predetermined number of units;
generating a search query that includes at least the determined preset purchase quantity and the desired unit price; and
using the search query to search for matching products, wherein a matching product is associated with a unit price corresponding to the determined preset purchase quantity that corresponds to the desired unit price.

2. The method of claim 1, further comprising returning search results including an identifier is associated with a matching product.

3. The method of claim 1, wherein, for a product, converting one or more user input purchase quantity ranges and corresponding unit prices into a set of preset purchase quantities and corresponding unit prices.

4. The method of claim 3, wherein converting one or more user input purchase quantity ranges includes determining whether there is a match, if any, between each of the set of preset purchase quantities and one of the one or more user input purchase quantity ranges, wherein a match exists between a preset purchase quantity and a user input purchase quantity range if the preset purchase quantity is equal to or greater than a lower limit associated with the user input purchase quantity range and if the preset purchase quantity is equal to or less than an upper limit associated with the user input purchase quantity range.

5. The method of claim 4, wherein in the event it is determined a match exists between a preset purchase quantity and a user input purchase quantity range, a corresponding relationship between the preset purchase quantity and a unit price associated with the matching user input purchase quantity range is stored for the product.

6. The method of claim 1, wherein the search request further includes one or more desired product attributes.

7. The method of claim 6, wherein the generated search query further includes the one or more desired product attributes.

8. The method of claim 7, wherein the matching product is further associated with the one or more desired product attributes.

9. The method of claim 1, wherein the determined preset purchase quantity is associated with a value closest to a value associated with the desired purchase quantity.

10. A system for searching product information, comprising:
a processor configured to:
receive a search request that includes at least a desired purchase quantity and a desired unit price;
determine a preset purchase quantity that corresponds to the desired purchase quantity, wherein the determined preset purchase quantity is selected from a set of preset purchase quantities and each of the set of preset purchase quantities is associated with a different predetermined number of units;
generate a search query that includes at least the determined preset purchase quantity and the desired unit price; and
use the search query to search for matching products, wherein a matching product is associated with a unit price corresponding to the determined preset purchase quantity that corresponds to the desired unit price; and
a memory coupled to the processor and configured to provide the processor with instructions.

11. The system of claim 10, wherein the processor is further configured to return search results including an identifier associated with a matching product.

12. The system of claim 10, wherein, for a product, one or more user input purchase quantity ranges and corresponding unit prices are converted into a set of preset purchase quantities and corresponding unit prices.

13. The system of claim 12, wherein to convert one or more user input purchase quantity ranges includes determining whether there is a match, if any, between each of the set of preset purchase quantities and one of the one or more user input purchase quantity ranges, wherein a match exists between a preset purchase quantity and a user input purchase quantity range if the preset purchase quantity is equal to or greater than a lower limit associated with the user input purchase quantity range and if the preset purchase quantity is equal to or less than an upper limit associated with the user input purchase quantity range.

14. The system of claim 13, wherein in the event it is determined a match exists between a preset purchase quantity and a user input purchase quantity range, a corresponding relationship between the preset purchase quantity and a unit price associated with the matching user input purchase quantity range is stored for the product.

15. The system of claim 10, wherein the search request further includes one or more desired product attributes.

16. The system of claim 15, wherein the generated search query further includes the one or more desired product attributes.

17. The system of claim 16, wherein the matching product is further associated with the one or more desired product attributes.

18. The system of claim 10, wherein the determined preset purchase quantity is associated with a value closest to a value associated with the desired purchase quantity.

19. A computer program product for searching product information, the computer program product being embodied in a computer readable medium and comprising computer instructions for:
receiving a search request that includes at least a desired purchase quantity and a desired unit price;
determining a preset purchase quantity that corresponds to the desired purchase quantity, wherein the determined preset purchase quantity is selected from a set of preset purchase quantities and each of the set of preset purchase quantities is associated with a different predetermined number of units;
generating a search query that includes at least the determined preset purchase quantity and the desired unit price; and
using the search query to search for matching products, wherein a matching product is associated with a unit price corresponding to the determined preset purchase quantity that corresponds to the desired unit price.
